(19) United States
(12) Patent Application Publication
(10) Pub. No.: US 2004/0203888 A1
(43) Pub. Date: Oct. 14, 2004

(54) System and method for changing presence of a communication device relative to location

(76) Inventor: Jeffrey Clinton Mikan, Cumming, GA (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/313,384

(22) Filed: Dec. 6, 2002

(51) Int. Cl. H04Q 7/20

(52) U.S. Cl. 455/456.1; 455/433

(57) ABSTRACT

The present invention is a method and system for changing the presence of a user profile logged into a communication device on a telecommunications network relative to the location of the communication device. In a first embodiment, the communication device receives location information of the communication device from the telecommunications network. The communication device then changes the presence of the user profile logged into the communication device to correspond with the presence associated with the location information. In a second embodiment, the communication device receives the location information via a client device, then adjusts the presence of the user profile logged into the communication device to the presence corresponding to location information.

### FIELD OF THE INVENTION

The present invention generally relates to the field of telecommunications, and more particularly, relates to a system and method for changing the presence of a user profile logged into a communication device on a telecommunications network relative to the location of the communication device.

### BACKGROUND OF THE INVENTION

Instant messaging services, accessible via a computer device or other communication device, enable users of such services to exchange messages or information with each other in near real-time. A feature of instant messaging services is a personal list, sometimes referred to as a “buddy list”, which includes identification of other users with whom the user frequently communicates via the instant messaging services. The availability status of other users on the personal list, known as the instant messaging presence of each user, includes not only “online” or “offline,” but user-controlled statuses that may indicate the location of the user, such as “gone to a movie,” “on the phone,” or “eating dinner.” Generally, the user-controlled statuses may be changed in response to an action received by the user interface, such as receipt of a selection of an instant messaging presence via a drop-down menu presented on the display of the communication device.

Currently, if a user wishes for other users on the personal list to know that the user is in a particular location, the user makes the selection of the appropriate instant messaging presence, such as “in a theater,” via the user interface on the communication device. Upon receipt of the change in instant messaging presence, the user device communicates a signal representative of the new instant messaging presence to messaging server via the telecommunications network. Then, upon receipt of this signal, the messaging server communicates the new instant messaging presence indicating the location of the user to the other users' personal lists by publishing the instant messaging presence on the display of each communication device.

However, there are many inconveniences posed to the user by this process. For instance, many users carry their communication devices with them almost everywhere. Many times, the user entering a particular location with the communication device may also warrant a change in the instant messaging presence of the communication device. Currently, there is no mechanism for automatically changing the instant messaging presence relative to the location of the device. Thus, in such a situation, the user must remember to change the instant messaging presence each time the user enters into a different location. Constantly changing the instant messaging presence each time the user enters a new location will not only become burdensome, but time consuming for the user.

This process may cause added aggravation for a user because the user may forget to change the instant messaging presence of the user profile logged into the communication device each time the user enters a different location. Another possibility is the user may be in too much of a hurry to make the change. In both of these predicaments, the user's instant messaging presence will not reflect the actual location and resulting availability of the user, and thus, the published instant messaging presence will be inaccurate.

In another situation, a communication device may be coupled to a client device, such as a personal computer, or a wireless device such as a personal digital assistant device (“PDA” device). Currently, in this situation, a user may change instant messaging presence via user interface of the client device. This process, however, also causes additional inconvenience to the user, for the user must take the additional step of changing the instant messaging presence via the client device each time the user enters a new location.

Therefore, there is a need in the art for system and method for changing the instant messaging presence of a user profile logged into a communication device relative to location of the communication device. There is also a need for an implementing such a feature in such a way that the customer, after entering a new location, is not required to take the step of changing the instant messaging presence of the communication device, even when the communication device is coupled to a client device.

### SUMMARY OF THE INVENTION

Generally stated, the present invention provides a method and apparatus for changing the instant messaging presence of a user profile logged into a communication device. In particular, the present invention provides a method and system for changing the instant messaging presence of a user profile logged into a communication device on a telecommunications network relative to the location of the communication device.

In the preferred embodiment, the method comprises the steps of receiving location information for the communication device and adjusting the presence in response thereto. The communication device receives the location information of the communication device from the telecommunications network. Once this location information is received, the communication device determines the new presence corresponding to location information by accessing a memory. The communication device then transmits a signal to change the presence of the communication device to the new presence associated with the location information.

In another disclosed embodiment, the method includes changing the presence in response to a change in location information of the communication device received from the telecommunications network by a client, such as a personal computer communicatively linked to a communication device. The telecommunications network communicates the change in location to the client. The client communicates the changed location information to the communications device. The communication device then determines the new presence, and communicates the new presence to the telecommunications network.

Therefore, it is an object of the present invention to provide a rapid and user friendly process for changing the presence of a user profile logged into a communication device on a telecommunications network relative to a change in the location of the communication device.

It is also an object of the present invention to provide a process for changing the presence of a user profile logged into a communication device relative to a change in location of the communication device when the communication device is coupled to a client device.

It is a further object of the present invention to provide a system for changing the presence of a user profile logged into a communication device on a telecommunications network relative to the location of the communication device.

Still another object of the present invention to provide an system for changing the presence of a user profile logged into a communication device on a telecommunications network relative to location of the communication device.

That the present invention and the preferred embodiment thereof overcome the drawbacks set forth above and accomplish the objects of the invention set forth herein will become apparent from detailed description of the present invention to follow.

### BRIEF DESCRIPTION OF THE DRAWINGS

Preferred and alternative embodiments will now be described with reference to the attached figures wherein like reference numerals indicate similar or identical features or functions, and wherein:

FIG. 1 is a block diagram representation illustrating an exemplary system in accordance with the first embodiment of the present invention.

FIG. 2 is a block diagram representation of the data storage unit of the communication device in accordance with the first and second embodiments of the present invention.

FIG. 3 is a block diagram representation representing an exemplary system in accordance with the second embodiment of the present invention.

FIG. 4 is a flow diagram illustrating the first embodiment of the present invention from the perspective of the communication device.

FIG. 5 is a flow diagram illustrating the second embodiment of the present invention from the perspective of the system.

### DETAILED DESCRIPTION OF THE INVENTION

Generally stated, the present invention provides a method and system for changing the presence of a user profile logged into a communication device on a telecommunications network. In particular, the present invention provides a method and system for changing the presence of a user profile logged into a communication device on a telecommunications network relative to the location of the communication device.

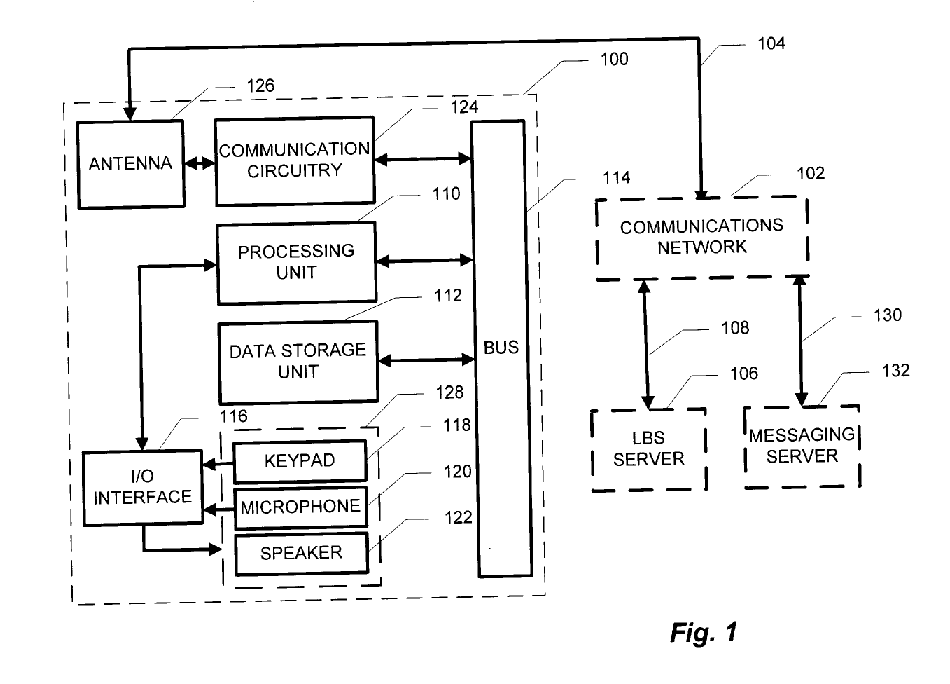

FIG. 1 is an overall system diagram illustrating the exemplary system in accordance with the first embodiment of the present invention. The communication device 100 places and receives calls with telecommunications network 102, in addition to any other communications, via a bi-directional communications link 104. Location based services (LBS server) 106 may also communicate with communication device 100, and is coupled to telecommunications network 102 via a bi-directional communications link 108. Messaging server 132 is also coupled to telecommunications network 102 via bi-directional communications link 130.

Communication device 100 may be any device capable of receiving and transmitting data. In the first and second embodiments of the present invention, this communication device 100 is a mobile device. Communication device contains a processing unit 110 which is communicatively coupled via bi-directional communications link to the other components of the communication device via a bus 114.

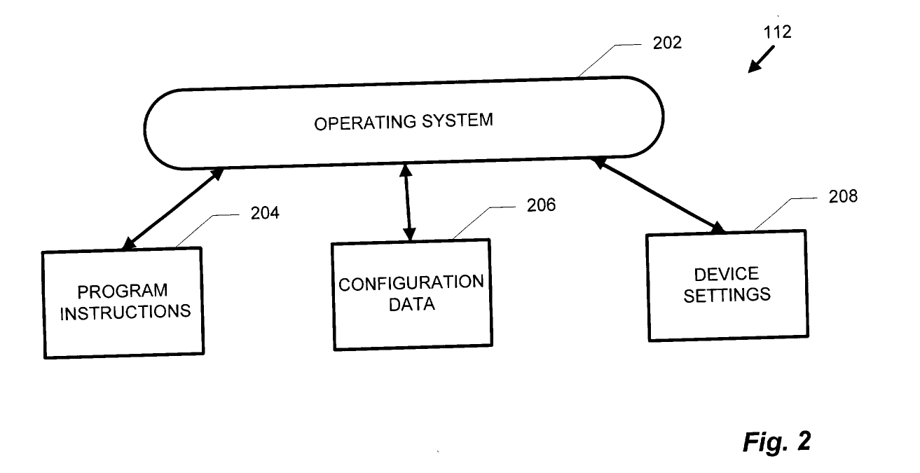

Communication device 100 contains a data storage unit 112, which is discussed in greater detail in FIG. 2. Data storage unit 112 may be any type of memory, including but not limited to RAM, EPROM, or EEPROM memory, and may store either volatile or non-volatile memory. The processing unit 110 and the data storage unit 112 may communicate via a system bus 114. Alternatively, the processing unit 110 and the data storage unit 112 may be included on the same microprocessing chip.

Communication device 100 also includes I/O interface 116, which may reside on the same microprocessing chip as the processing unit 110. However, I/O interface 116 may also reside on an external unit. I/O interface 116 connects the processing unit 110 to a user interface 128. In the case of a wireless device such as a cellular telephone, user interface 128 comprises keypad input 118, microphone input 120, and speaker output 122. The I/O interface 116 may include an analog-to-digital converter for converting an analog microphone signal to a digital signal for use by the processing unit 110. I/O interface 116 may also include a digital-to-analog converter to convert digital information from the processing unit 110 to the speaker 122, such as voice data.

The processing unit 110 transmits and receives digital signals which are to be communicated outside the communication device 100 via the communication circuitry 124. In a cellular telephone embodiment, the communication circuitry 124 is connected to an antenna 126, which communicates signals through airwaves to telecommunications network 102 via a bi-directional communication link 104 when such a link is established, i.e., when a call is placed to or from the communication device 100.

Telecommunications network 102 receives signals, including but not limited to location information, from the communication device 100 via antenna 126. Telecommunications network 102 includes various components required to enable communication between two or more communication devices, including wired connections, wireless connections, switches, and other devices for establishing communication in the network.

Telecommunications network 102 is communicatively coupled to a location based services server 106 via a bidirectional communication link 108. This location based services server 106 may be any computer system with the capability to determine the location of a communication device. Telecommunications network 102 is also coupled to messaging server 132 via bi-directional communications link 130. This messaging server 132 may be any computer system communicating with the telecommunications network 102 to provide messaging capabilities to communication devices on telecommunications network 102, including a server of a wireless service provider.

FIG. 2 is a block diagram representation of the data storage unit 112 of the communication device in accordance with the first and second embodiments of the present invention. Data storage unit 112 comprises operating system 202, which contains instructions for operating the communication device 100. In addition to any other instructions, the program instructions unit 204 includes instructions, which when executed by processing unit 110, execute the methods disclosed in the first and second embodiments of the present invention. The configuration data unit 206 is included in the data storage unit 112, and contains configuration information regarding the assortment of components that make up the system of the present invention.

The data storage unit 112 also contains a device settings unit 208. The device settings unit 208 contains various parameters indicating the settings of the communication device 100, in addition to any other data. One of these parameters may include a value for indicating the presence associated with a particular location of the communication device 100. Other device settings which may be stored in the device settings unit 208 include, but are not limited to, ring type, touch tone type, or appearance of the user interface 128.

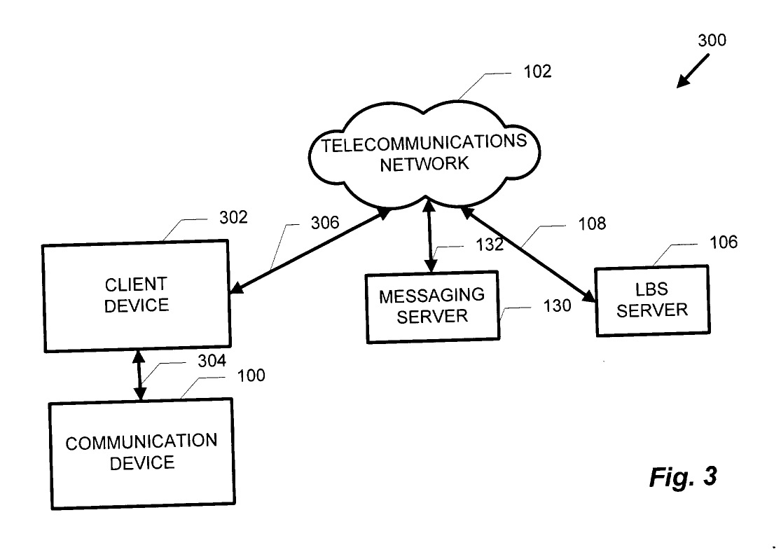

FIG. 3 is a block diagram representation representing an exemplary system in accordance with the second embodiment of the present invention. System 300 involves a communication device 100 connected to a client device 302. An example of this embodiment includes a personal computer with telephonic capabilities incorporated within the functionality of the computer, wherein the telephonic capabilities may be operated via the user interface of the personal computer. Another example of this embodiment includes a wireless device communicatively coupled to another device such as a personal digital assistant device (“PDA” device), wherein the user may control the operation of the communication device via the interface of the PDA device.

In this second embodiment, the communication device 100 is the same communication device 100 described in FIG. 1. Communication device 100 is connected via a bidirectional communications link 304 to client device 302. Bi-directional link 304 may be a wireless link, established via a wireless data transfer protocol such as the Bluetooth technology, or a wired connection.

The client device 302 may, but is not required to, contain substantially the same components as the communication device 100 as described in FIG. 1. However, the client device 302 may comprise any device capable of operating with a communication device 100 such as a personal computer or another wireless device. Bi-directional communication link 104 communicatively couples the client device 302 and the telecommunications network 102. Bi-directional link 104 may be a wireless link, established via a wireless data transfer protocol such as the Bluetooth technology, or alternatively, a wired connection.

LBS server 106 is any server capable of determining the precise location of the user. The LBS server 106 communicates location information to the telecommunications network 102 via bi-directional communications link 108. The location information then is transmitted to the client device 302 via bi-directional communications link 108, which also may be a wired or wireless connection.

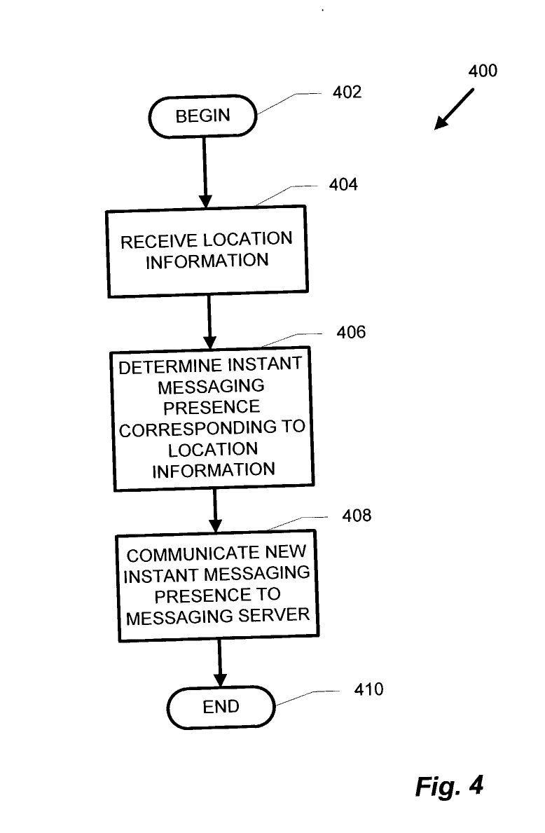

FIG. 4 is a flow diagram illustrating the method of the first embodiment of the present invention. Method 400 begins at step 402 and proceeds to the receipt of location information at step 404. More particularly, at step 404 the processing unit 110 receives a signal indicating a change in location of the communication device.

The receipt of location information may be the result of various processes depending on the capabilities and functionality of the communication device 100. These processes include, but are not limited to, a request by communication device 100 for location information by communication device 100 or as the result of a push of location information to communication device 100 by LBS server 106 over telecommunications network 102. The location information may take on any form sufficient to identify the location of the user, including but not limited to, x and y coordinate data, or latitude/longitudinal data.

At step 406, the communication device 100 determines the new presence corresponding to the new location. A specific presence may be programmed to be associated with a specific location area. These presences, and their accompanying location information, may be stored in the memory of the communication device 100 in the device settings unit 208 of the data storage unit 112. However, these presences may also reside externally in an alternate memory. The presence associated with a location may be programmed by the user via the user interface 128 of communication device 100, may be preprogrammed into the device settings component 208 of the data storage unit 112 of communication device 100 at the time of manufacture, or may reside on the telecommunications network 102 for communication to the communication device 100.

At step 408, the communication device changes the presence of the user profile logged into the communication device 100 to the new presence. This new presence is communicated to the messaging server 132, where is stored until the presence changes. The method 400 then concludes at step 410 after the presence of the communication device 100 are changed to reflect the new location.

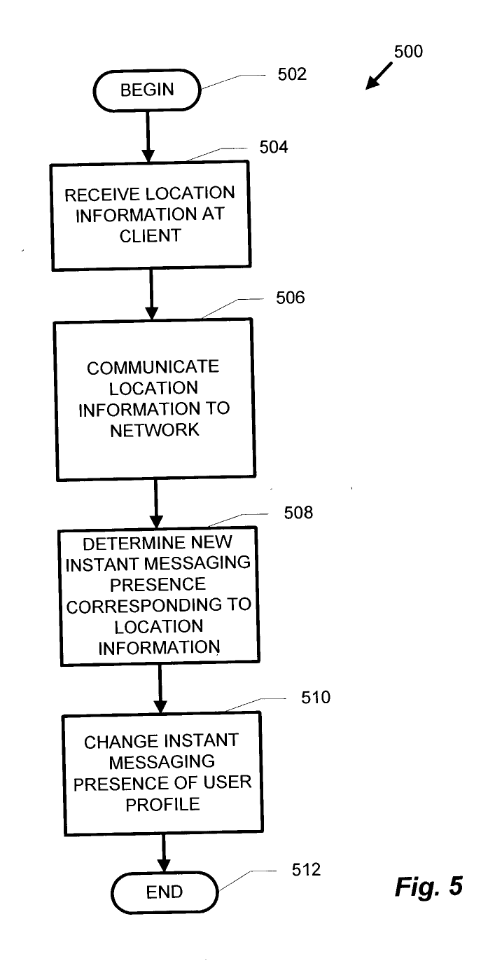

FIG. 5 is a flow diagram illustrating the second embodiment of the present invention. Method 500 is utilized when the communication device 100 is connected to a client device 302 in accordance with the second embodiment of the present invention. After method 500 begins at step 502, the client device 302 receives a change in location information at step 504. The possible forms for location information include, but are not limited to, x and y coordinate data, or latitude/longitudinal data. Furthermore, the client device 302 may receive the location information in response to a request by the client device 302 for location information for communication device 100 or as the result of a push of the location information to the client device 302 by LBS server 106 over the telecommunications network 102.

At step 506, the client device 302 communicates the location information to the communication device 100. The client device 302 may communicate to the communication device 100 in any capable form, including but not limited to a wireless technology, such as a short-range radio technology including Bluetooth, or a wired connection.

At step 508, the communication device 100 determines the presence corresponding to the new location. The presence associated with specific location information may be stored in memory of the communication device 100, or also, may reside in an external memory. At step 510, the communication device 100 communicates the new presence to the client device which in turn, communicates the new presence to the messaging server 132 via the telecommunications network 102. Method 500 concludes at step 512.

It will be apparent to those skilled in the art that various changes and modifications of an obvious nature may be made to the present invention, and all such changes and modifications are considered to fall within the scope of the appended claims. Other embodiments of this invention will be apparent to those skilled in the art from consideration of the specification and practice of the invention disclosed herein. It is intended that the specification and examples be considered as exemplary only, and within the scope and spirit of the invention as indicated in the description and the following claims.

I hereby claim:

1. A method of changing the presence of a user profile logged into a communication device on a telecommunications network relative to a change in the location of the communication device, said method comprising:
receiving location information for the communication device;
determining a presence corresponding to the location information; and
communicating the presence corresponding to the location information to the telecommunications network.

2. The method of claim 1, wherein said receiving location information step comprises receiving x and y coordinates reflecting the location of the communication device.

3. The method of claim 1, wherein said receiving location information step comprises receiving latitude data and longitude data reflecting the location of the communication device.

4. The method of claim 1, wherein said receiving location information step comprises receiving location information after requesting location information from the telecommunications network.

5. The method of claim 1, wherein said determining presence corresponding to location information step comprises retrieving the presence corresponding to the location information from a memory.

6. The method of claim 5, wherein retrieving the presence corresponding to the location information from a memory comprises accessing a memory in the communication device.

7. The method of claim 5, wherein retrieving the presence corresponding to the location information from a memory comprises accessing a memory coupled to the telecommunications network.

8. The method of claim 1, wherein said communication device comprises a wireless device.

9. The method of claim 8, wherein said communication device is a cellular telephone.

10. The method of claim 9, wherein said cellular telephone is communicatively coupled to a client device.

11. A computer readable medium, said computer readable medium containing instructions to perform the steps of claim 1.

12. A method of changing the presence of a user profile logged into a communication device on a telecommunications network relative to a change in the location of the communication device, said method comprising:
receiving location information of the communication device on the telecommunications network;
communicating the location information to a communication device;
determining a presence corresponding to location information; and
changing the presence of the user profile logged into the communication device to the presence corresponding to the location information.

13. The method of claim 12, wherein said receiving location information step comprises receiving x and y coordinates reflecting the location of the communication device.

14. The method of claim 12, wherein said receiving location information step comprises receiving latitude and longitude data reflecting the location of the communication device.

15. The method of claim 12, wherein said receiving location information step comprises receiving location information after requesting location information from the telecommunications network.

16. The method of claim 12, wherein said determining presence corresponding to location information step comprises retrieving the presence corresponding to the location information from a memory.

17. The method of claim 16, wherein retrieving the presence corresponding to the location information from a memory comprises accessing a memory in the communication device.

18. The method of claim 16, wherein retrieving the presence corresponding to the location information from a memory comprises accessing a memory connected to the telecommunications network.

19. The method of claim 12, wherein said communication device comprises a wireless device.

20. The method of claim 19, wherein said communication device is a cellular telephone.

21. A computer readable medium, said computer readable medium containing instructions to perform the steps of claim 12.

22. A system for changing the presence of a user profile logged into a telecommunications network based at least in part on the location of the communication device, said system comprising:
a processing unit resident in the communication device;
a memory accessible to said processing unit for storing a presence value related to a location value of the communication device, said location value changing upon physical transgression of the communication device and being representative of a location of the communication device; and
a plurality of instructions executable by said processing unit to cause alteration of the presence value of the communication device based at least in part on said location value.

23. The system of claim 22, wherein said system further comprises a network interface communicatively connected to said processing unit for receipt of the location value from the telecommunications network.

24. The system of claim 22, wherein said system further comprises a user interface communicatively connected to said processing unit for receipt of input from a user of the communication device corresponding to a mode of operation desired by the user for a location value.

25. The system of claim 24, wherein said user interface comprises a keypad.

26. The system of claim 24, wherein said user interface comprises a microphone.

27. The system of claim 24, wherein said user interface further comprises a speech recognition unit.

28. The system of claim 24, wherein said user interface comprises a touch screen.

29. The system of claim 22, wherein said plurality of instructions is a first plurality of instructions and said system further comprises a second plurality of instructions executable by said processing unit to cause storage of said data value in response to the receipt of input via said user interface.
